(19) United States
(12) Patent Application Publication
(10) Pub. No.: US 2015/0169005 A1
(43) Pub. Date: Jun. 18, 2015

(54) ELECTRONIC DEVICE AND TOUCHPAD ASSEMBLY

(71) Applicant: Kabushiki Kaisha Toshiba, Tokyo (JP)

(72) Inventor: Atsuhiro Yanagida, Hamura Tokyo (JP)

(21) Appl. No.: 14/632,953

(22) Filed: Feb. 26, 2015

Related U.S. Application Data
(63) Continuation of application No. PCT/JP2013/057271, filed on Mar. 14, 2013.

(51) Int. Cl. G06F 1/16; G06F 3/0354; G06F 3/041

(52) U.S. Cl. CPC G06F 1/1643; G06F 3/041; G06F 3/03547

(57) ABSTRACT

According to one embodiment, an electronic device includes a housing provided with an opening, a touchpad unit, a supporting portion, an operation unit, and a reinforcing member. The touchpad unit is exposed from the opening, comprises an operation surface, and is configured to detect operations on the operation surface. The supporting portion is configured to be plate-like, is supported by the housing, and is configured to displaceably support the touchpad unit. The operation unit is configured to be depressed as the touchpad unit is displaced. The reinforcing member is configured to be plate-like, is fixed in a state of overlapping the touchpad unit or the supporting portion, and is made of a material harder than the supporting portion.

### CROSS-REFERENCE TO RELATED APPLICATIONS

This application is a continuation of International Application No. PCT/JP2013/057271, filed on Mar. 14, 2013, the entire contents of which are incorporated herein by reference.

### FIELD

Embodiments described herein relate generally to an electronic device and a touchpad assembly.

### BACKGROUND

Conventionally, electronic devices are known that comprise a touchpad unit that can be operated by being depressed.

In such a kind of electronic devices, there are cases in which, as an example, deformation of the touchpad unit can preferably be reduced.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an example of an electronic device according to an embodiment;

FIG. 2 is an exemplary plan view of a first housing of the example of the electronic device in the embodiment;

FIG. 3 is an exemplary cross-sectional view of FIG. 2 in the embodiment;

FIG. 4 is an exemplary exploded perspective view of a part of the first housing of the example of the electronic device in the embodiment;

FIG. 5 is an exemplary perspective view, as viewed from the back side, of the first housing and a touchpad assembly mounted on the first housing of the example of the electronic device in the embodiment;

FIG. 6 is an exemplary perspective view, as viewed from the back side, of a touchpad unit comprised in the touchpad assembly of the example of the electronic device in the embodiment;

FIG. 7 is an exemplary perspective view, as viewed from the surface side, of a supporting portion comprised in the touchpad assembly of the example of the electronic device in the embodiment;

FIG. 8 is an exemplary perspective view, as viewed from the surface side, of a reinforcing member comprised in the touchpad assembly of the example of the electronic device in the embodiment; and

FIG. 9 is an exemplary exploded perspective view of a touchpad assembly of an electronic device according to a modification of the embodiment.

### DETAILED DESCRIPTION

In general, according to one embodiment, According to one embodiment, an electronic device comprises a housing provided with an opening, a touchpad unit, a supporting portion, an operation unit, and a reinforcing member. The touchpad unit is exposed from the opening, comprises an operation surface, and is configured to detect operations on the operation surface. The supporting portion is configured to be plate-like, is supported by the housing, and is configured to displaceably support the touchpad unit. The operation unit is configured to be depressed as the touchpad unit is displaced. The reinforcing member is configured to be plate-like, is fixed in a state of overlapping the touchpad unit or the supporting portion, and is made of a material harder than the supporting portion.

An exemplary embodiment and a modification thereof given below comprise the same components. Accordingly, in the following, common reference numerals will be given to the same components, and duplicate description thereof will be omitted. Parts comprised in each of the embodiment and the modification thereof can be configured by being replaced with corresponding parts of other embodiments or modifications thereof.

While the following embodiment illustrates a case in which an electronic device is configured as a clamshell (notebook or foldable) personal computer, the electronic device according to the present embodiment is not limited to these types. The electronic device according to the present embodiment can be configured as a personal computer of other types or an electronic device, such as a keyboard unit, that comprises a touchpad.

### Embodiment

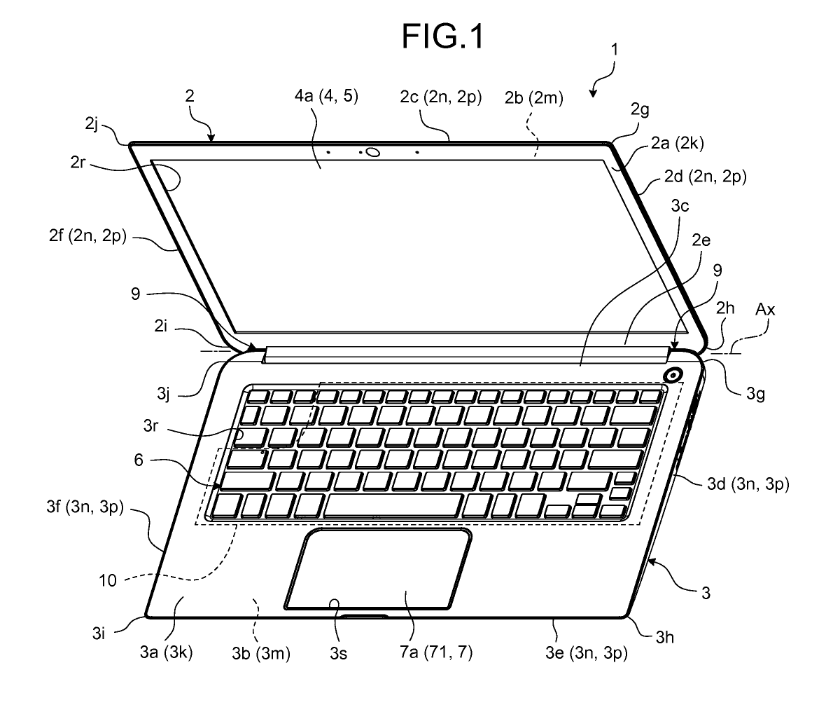

In the present embodiment, as an example, as illustrated in FIG. 1, an electronic device 1 comprises a housing 2 (second housing, other housing, or second portion) and a housing 3 (first housing or first portion). The housing 2 supports a display device 4. The housing 3 houses a circuit board (or boards) 10. The housing 3 is provided with, for example, a keyboard 6 (input operation unit, input accepting unit, or input unit) and a touchpad assembly 7 (input operation unit, input accepting unit, or input unit).

The housing 2 is rotatably connected to the housing 3 by a hinge portion 9 (connecting portion, joining portion, rotary supporting portion, hinge mechanism, connecting mechanism, joining mechanism, or rotary supporting mechanism). The housing 2 is connected to the housing 3 by the hinge portion 9 so as to be rotatable at least between an unfolded state illustrated in FIG. 1 and a folded state, which is not illustrated. In the present embodiment, as an example, the hinge portion 9 connects the housing 2 to the housing 3 so as to be rotatable about a rotation axis Ax. A display screen 4a of the display device 4 can be viewed through an opening 2r provided in a face 2a of the housing 2. For example, the keyboard 6 and the touchpad assembly 7 are exposed on a face 3a of the housing 3. In the folded state, the face 3a of the housing 3 and the face 2a of the housing 2 are superimposed on each other, and, for example, the display screen 4a, the keyboard 6, and the touchpad assembly 7 are hidden by the housing 2 and the housing 3. In the unfolded state, the face 3a of the housing 3 and the face 2a of the housing 2 are exposed, and, for example, the display screen 4a, the keyboard 6, and the touchpad assembly 7 can be used (can be viewed or operated).

In the present embodiment, as an example, as illustrated in FIG. 1, the housing 2 has an external appearance of a quadrilateral shape (horizontally long rectangular shape, as an example, in the present embodiment) in the front view and the rear view. In the present embodiment, as an example, the housing 2 is configured in a flat cuboid shape that is thin in the front-rear direction (thickness direction of the housing 2). The housing 2 comprises the face 2a (front face, anterior face, or face portion), a face 2b (rear face, posterior face, or face portion) on the opposite side thereof, and a face 2p (side face or face portion) crossing between the face 2a and the face 2b. Both the face 2a and the face 2b intersect the thickness direction. The face 2a and the face 2b are substantially parallel to each other. The faces 2a and 2b intersect the face 2p (at a right angle, as an example, in the present embodiment). In the front view, the housing 2 comprises four end portions 2c to 2f (side portions, edge portions, or rim portions) and four corner portions 2g to 2j (apex portions, curved portions, or end portions). The end portions 2c and 2e are examples of long sides. The end portions 2d and 2f are examples of short sides.

The housing 2 comprises a wall portion 2k (portion, plate, anterior wall portion, surface wall portion, or top wall portion), a wall portion 2m (portion, plate, posterior wall portion, back wall portion, or bottom wall portion), and a wall portion 2n (portion, plate, side wall portion, end wall portion, standing wall portion, or crossing portion). The wall portion 2k comprises the face 2a. The wall portion 2m comprises the face 2b. The wall portion 2n comprises the face 2p. Both the wall portions 2k and 2m have a quadrilateral shape (rectangular shape, as an example, in the present embodiment). All the wall portions 2k, 2m, and 2n are plate-like. The wall portion 2k is provided with the opening 2r having a quadrilateral shape. The housing 2 can be made, for example, of a metal material or a synthetic resin material. The metal material can be formed, for example, by casting, pressing, or cutting. The synthetic resin material can be formed, for example, by injection molding. The housing 2 can comprise a plurality of members (parts or split bodies).

In the present embodiment, as an example, the housing 2 houses the display device 4 (display unit, display, panel, or display part). Specifically, a user can view the display screen 4a of the display device 4 from the front side through the opening 2r. The display device 4 has an external appearance of a quadrilateral shape (rectangular shape, as an example, in the present embodiment) in the front view. The display device 4 is configured in a flat cuboid shape that is thin in the front-rear direction. The display device 4 is, for example, a liquid-crystal display (LCD) or an organic electroluminescent display (GELD). The display device 4 may be a flexible display.

In the present embodiment, as an example, a relatively thin transparent input operation panel 5 (touch panel, touch sensor, operation surface, input operation unit, or input accepting unit) having a quadrilateral shape is provided on the anterior side (front side or wall portion 2k side) of the display device 4. The input operation panel 5 covers the display screen 4a. An operator (such as the user) can perform input processing by performing an operation, such as touching, pressing, or rubbing the input operation panel 5 with, for example, a finger or a stylus, or moving, for example, the finger or the stylus near the input operation panel 5. Light coming out of the display screen 4a of the display device 4 passes through the input operation panel 5, and exits toward the front (outside) of the housing 2 from the opening 2r of the wall portion 2k. The input operation panel 5 is an example of an input unit. In the present embodiment, as an example, the display device 4 and the input operation panel 5 are fixed to (supported on) the housing 2 via, for example, joint fittings (joint parts or fixing parts, such as screws, metal fittings, or parts, which are not illustrated) or bonding parts (such as adhesives or double-sided tapes, which are not illustrated). The input operation panel 5 may be configured as an in-cell touch panel comprised in the display device 4.

In the present embodiment, as an example, as illustrated in FIG. 1, the housing 3 has an external appearance of a quadrilateral shape (horizontally long rectangular shape, as an example, in the present embodiment) in the front view and the rear view. As illustrated in FIG. 1, the housing 3 is configured in a flat cuboid shape that is thin in the up-down direction (thickness direction of the housing 3). The housing 3 comprises the face 3a (upper face, top face, or face portion), a face 3b (lower face, bottom face, or face portion) on the opposite side thereof, and a face 3p (side face or face portion) crossing between the face 3a and the face 3b. Both the face 3a and the face 3b intersect the thickness direction. The face 3a and the face 3b are substantially parallel to each other. The faces 3a and 3b intersect the face 3p (at a right angle, as an example, in the present embodiment). In the front view, the housing 3 comprises four end portions 3c to 3f (side portions, edge portions, or rim portions) and four corner portions 3g to 3j (apex portions, curved portions, or end portions). The end portions 3c and 3e are examples of long sides. The end portions 3d and 3f are examples of short sides.

The housing 3 comprises a wall portion 3k (portion, plate, upper wall portion, surface wall portion, or top wall portion), a wall portion 3m (portion, plate, lower wall portion, back wall portion, or bottom wall portion), and a wall portion 3n (portion, plate, side wall portion, end wall portion, standing wall portion, or crossing portion). The wall portion 3k comprises the face 3a. The wall portion 3m comprises the face 3b. The wall portion 3n comprises the face 3p. Both the wall portions 3k and 3m have a quadrilateral shape (rectangular shape, as an example, in the present embodiment). All the wall portions 3k, 3m, and 3n are plate-like. The wall portion 3k is provided with an opening 3r having a quadrilateral shape. The housing 3 can be made, for example, of a metal material or a synthetic resin material. The metal material can be formed, for example, by casting, pressing, or cutting. The synthetic resin material can be formed, for example, by injection molding. The housing 3 can comprise a plurality of members (parts or split bodies).

In the present embodiment, as an example, the housing 3 houses one or more circuit boards 10 (substrates, parts, electric components, or substrate assemblies). The circuit board (or boards) 10 is (are) provided in parallel with the keyboard 6. The circuit board (or boards) 10 is (are) fixed to the housing 3 by joint fittings (not illustrated).

In the present embodiment, as an example, a plurality of parts (electronic components, semiconductor electronic components, electric components, packages, which are not illustrated), such as a central processing unit (CPU), a graphic controller, power supply circuit parts, a Platform Controller Hub (PCH), a memory slot connector, an LCD connector, an input/output (I/O) connector, a power supply coil, elemental devices, and connectors, can be mounted on the circuit board (or each of the circuit boards) 10. A control circuit (not illustrated) formed on the circuit board (or each of the circuit boards) 10 can comprise, for example, a video signal processing circuit, a tuner, a high-definition multimedia interface (HDMI) signal processor, an audio/video (AV) input terminal, a remote control signal receiver, a controller, a selector, an on-screen display interface, storage units (such as a read-only memory [ROM], a random access memory [RAM], a hard disk drive [HDD], and a solid-state drive [SSD]), and an audio signal processing circuit. The control circuit controls, for example, output of pictures (such as moving images and still images) on the display screen 4a of the display device 4, output of sound from a speaker (or speakers) (not illustrated), and emission of light from light-emitting diodes (LEDs) (not illustrated). The display device 4, the speaker (or speakers), and the LEDs are examples of output units.

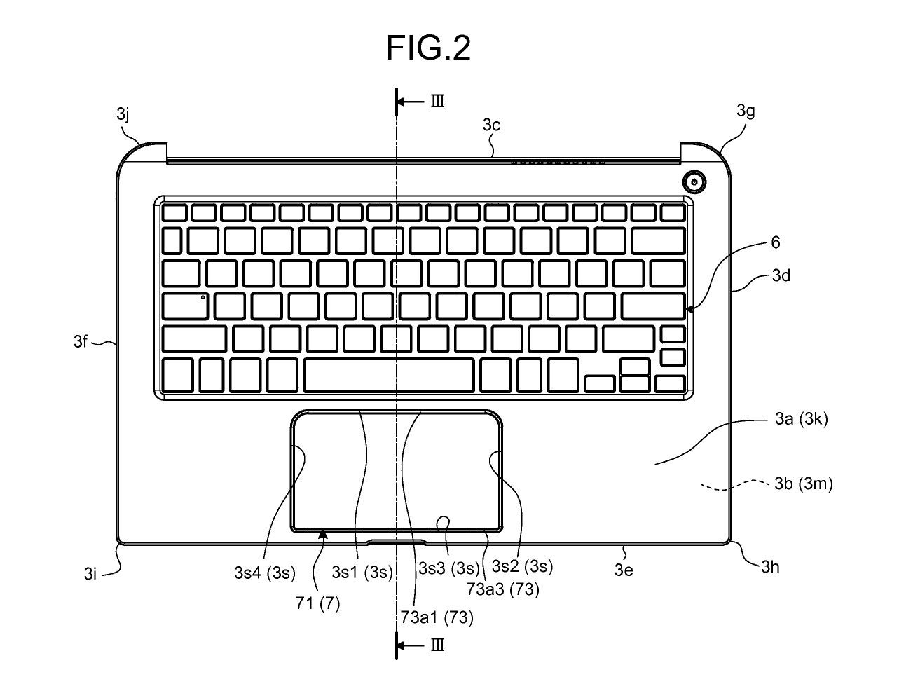

In the present embodiment, as an example, as illustrated, for example, in FIG. 1, the touchpad assembly 7 is exposed from an opening 3s provided in the wall portion 3k of the housing 3. The opening 3s is positioned on the side of the keyboard 6 nearer to the end portion 3e (opposite to the housing 2 and the hinge portion 9 and nearer to the user during use). The opening 3s is positioned in a middle portion in the longitudinal direction of the end portion 3e. The opening 3s is configured in a quadrilateral shape (rectangular shape, as an example, in the present embodiment). The opening 3s comprises four end portions 3s1 to 3s4 (edge portions or side portions, refer to FIG. 2).

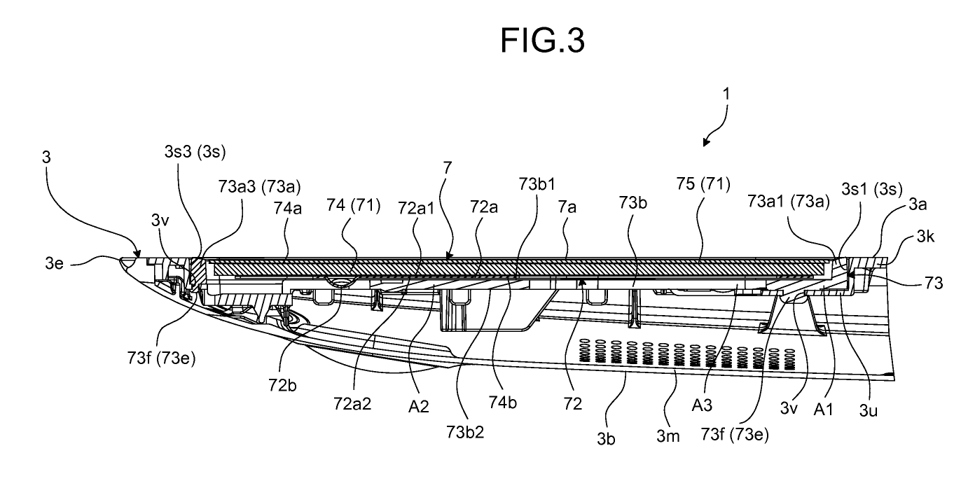

In the present embodiment, as an example, the touchpad assembly 7 comprises a function as a touchpad that is operated such that a face 7a (surface, upper face, or operation surface) thereof is traced, and a function as a click button that is operated such that the face 7a is depressed in the thickness direction of the housing 3 (the thickness direction of the touchpad assembly 7 or the laminating direction of components of the touchpad assembly 7) toward the face 3b side (the inside or lower side of the housing 3) on the opposite side of the face 3a. That is, the touchpad assembly 7 is supported in the opening 3s so as to be displaceable (retractable) in the thickness direction of the housing 3. In the present embodiment, as an example, an area of the touchpad assembly 7 on the end portion 3s1 side of the opening 3s (refer to FIGS. 2 and 3) is supported by the housing 3. An area of the touchpad assembly 7 on the end portion 3s3 side opposite to the end portion 3s1 side is displaced (depressed) in the opening 3s. In the state in which the touchpad assembly 7 is depressed, the touchpad assembly 7 is inclined into an attitude of being upper (on the face 3a side of the housing 3) on the keyboard 6 side and lower on the end portion 3e side.

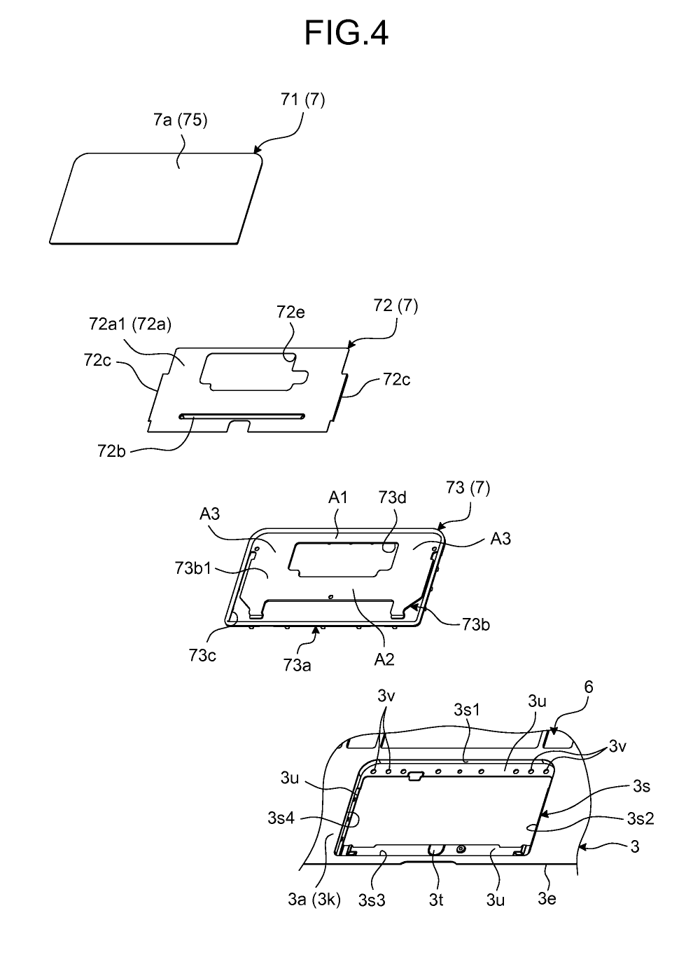

In the present embodiment, as an example, as illustrated in FIGS. 3 and 4, the touchpad assembly 7 comprises, for example, a touchpad unit 71, a reinforcing member 72, and a supporting member 73. All of the touchpad unit 71, the reinforcing member 72, and the supporting member 73 are configured in a plate-like (thin plate-like) manner, and are stacked on one another in this order. In the present embodiment, as an example, the touchpad unit 71, the reinforcing member 72, and the supporting member 73 are bonded with one another via adhesives (adhesive layers or adhesive sheets, which are not illustrated), and integrated into one body.

In the present embodiment, as an example, as illustrated in FIGS. 3 and 6, the touchpad unit 71 comprises a substrate 74 (supporting substrate, base, or base portion) and a touchpad 75. The substrate 74 is configured in a quadrilateral shape and in a plate-like (thin plate-like) manner. The substrate 74 is, as an example, a printed wiring board. The substrate 74 comprises, for example, a face 74a (upper face or surface), a face 74b (lower face or back face) on the opposite side thereof, and end portions 74c to 74f. The touchpad 75 is joined (integrated) with the face 74a of the substrate 74 by an adhesive or the like so as to configure the touchpad unit 71. The touchpad unit 71 can be configured as a unit having a different configuration from that of the present embodiment comprising the touchpad 75.

The face 7a of the touchpad 75 positioned on the opposite side of the face 74a of the substrate 74 corresponds to the outer face (surface, upper face, or exposed face) of the touchpad assembly 7. While the touchpad 75 can be configured, for example, as an electrostatic capacitance touch sensor (detector or operation detector), the touchpad 75 is not limited to this example.

As illustrated in FIG. 6, electronic components (electric components or parts), such as a connector 76, an elemental device 77 (integrated circuit [IC]), and a switch 78, are mounted on the face 74b of the substrate 74. Wiring (harness) is electrically connected to the connector 76. The touchpad 75 is electrically connected to the circuit board (or boards) 10, for example, via conductors of the substrate 74, conductors of the connector 76, conductors of the harness, and conductors of a connector (not illustrated) of the harness on the opposite side of the connector 76.

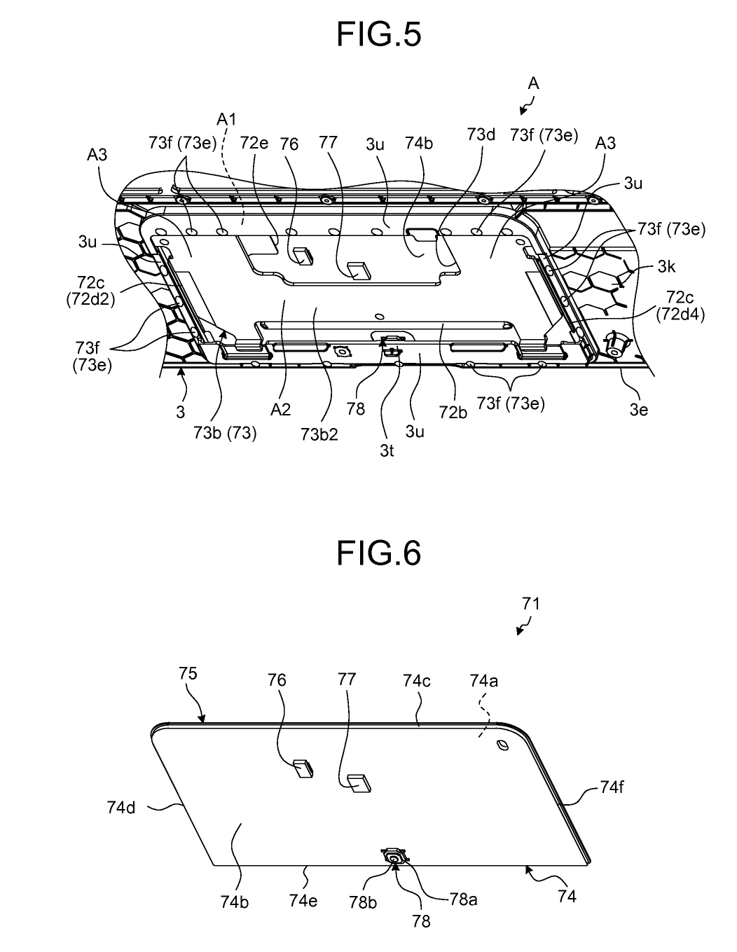

The switch 78 (operation unit) comprises a body 78a and a movable portion 78b. The body 78a is attached to the face 74b of the substrate 74, for example, by being soldered thereto. The movable portion 78b is supported on the body 78a so as to be displaceable (projectable and depressible, or retractable) in the thickness direction of the substrate 74 (the thickness direction of the touchpad unit 71, the thickness direction of the touchpad assembly 7, or the thickness direction of the housing 3). The contact points (not illustrated) of the switch 78 are electrically connected to the circuit board (or boards) 10, for example, via conductors of the substrate 74, conductors of the connector 76, conductors of the harness, and conductors of a connector (not illustrated) of the harness on the opposite side of the connector 76. The switch 78 is a normally open switch. When the movable portion 78b is depressed (retracted) toward the inside of the body 78a, the switch 78 is placed in the on state, a circuit for entering an operation signal (current or voltage) is closed, and the operation signal is sent to the circuit board (or boards) 10. When the touchpad assembly 7 is depressed by the operator toward the inside of the housing 3, the substrate 74 (the touchpad unit 71 or the touchpad assembly 7) comes close to a pressing portion 3t of the housing 3 (refer to FIGS. 4 and 5). As a result, the movable portion 78b is depressed toward the inside of the body 78a, and the switch 78 is placed in the on state. In this manner, the function of the touchpad assembly 7 as a click button is obtained. The switch 78 may be provided on the housing 3 side instead of on the touchpad assembly 7.

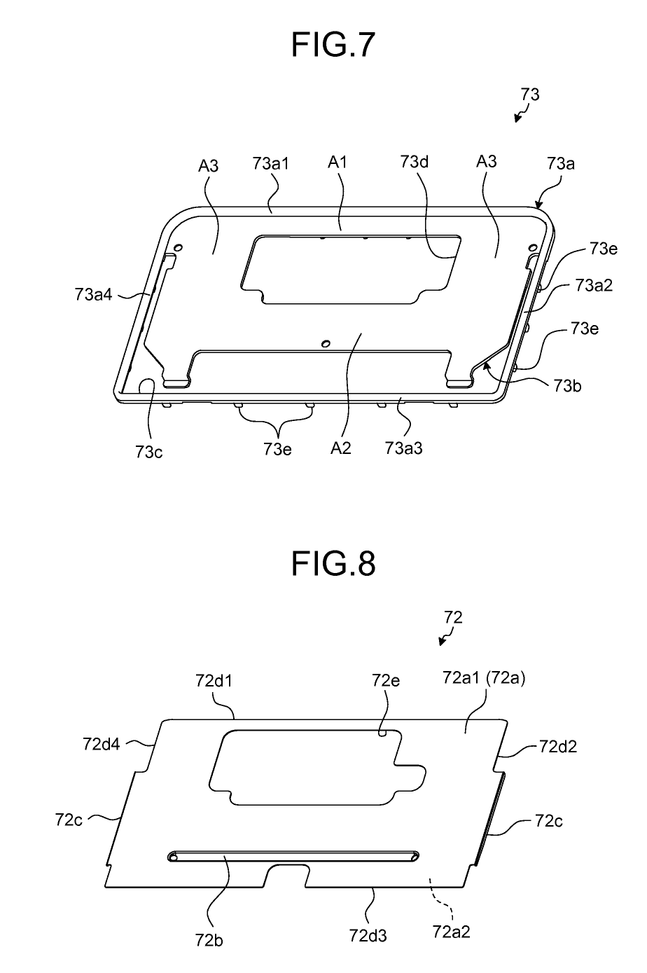

In the present embodiment, as an example, as illustrated in FIG. 7, the supporting member 73 comprises a frame portion 73a (outer portion) and a supporting portion 73b (wall portion, plate-like portion, plate portion, or inner portion). The frame portion 73a is positioned at the rim portion of the supporting member 73, and is configured in a quadrilateral (rectangular, as an example, in the present embodiment) and frame-like shape. The frame portion 73a comprises end portions 73a1 to 73a4. As illustrated in FIGS. 1 and 2, the frame portion 73a is (the end portions 73a1 to 73a4 are) positioned between rim portions (end portions, edge portions, or side portions) of the substrate 74 and the touchpad 75 of the touchpad unit 71 and the end portions 3s1 to 3s4 (edge portions or side portions) of the opening 3s, in the state of being configured as the touchpad assembly 7. That is, the frame portion 73a is contained in a gap having a substantially constant width formed between the touchpad unit 71 and the opening 3s. Hence, according to the present embodiment, as an example, advantages are obtained such that appearance can be improved and, for example, foreign matter and liquid are kept from entering the housing 3 through the gap.

The supporting portion 73b is positioned inside the frame portion 73a, and is configured in a quadrilateral (rectangular, as an example, in the present embodiment) and frame-like shape. The supporting portion 73b is joined (connected) with the end portion 73a1 of the frame portion 73a, but not joined with the end portion 73a3 or portions on the end portion 73a3 side of the end portions 73a2 and 73a4. That is, a substantially U-shaped opening 73c (slit) is provided along the end portions 73a2 to 73a4 between the frame portion 73a and the supporting portion 73b. The supporting portion 73b comprises a face 73b1 (upper face) and a face 73b2 (lower face, refer to FIGS. 3 to 5). The supporting portion 73b is provided with an opening 73d in a position near the end portion 73a1. The opening 73d is configured in a quadrilateral shape (rectangular shape, as an example, in the present embodiment). In the present embodiment, as an example, by providing the openings 73c and 73d, an area A1 along the end portion 73a1 and a U-shaped area A2 along the end portions 73a2 to 73a4 are formed on the supporting portion 73b. The area A1 of the supporting portion 73b is a portion (supported portion, fixed portion, or joined portion) that is supported (fixed or joined) on the housing 3 while hardly moving relative to the wall portion 3k of the housing 3 even when the touchpad assembly 7 is depressed toward the inside of the housing 3. That is, the area A1 is an example of a position of the supporting portion 73b supported by the housing 3. The area A2 of the supporting portion 73b is a portion (supporting portion) that supports the touchpad unit 71 regardless of whether the touchpad assembly 7 is depressed. Areas A3 positioned in boundaries between the area A1 and the area A2 are portions (deformed portions, bending portions, elastic deformation portions, or spring portions) that are elastically (recoverably) deformed (bent) when touchpad assembly 7 is depressed. At least an elastically deformed portion of the supporting member 73 (the whole of the supporting member 73, as an example, in the present embodiment) is made of a synthetic resin material having elasticity (flexibility). With such a configuration of the supporting portion 73b, an operation of returning to an initial position (original position) is obtained after the touchpad assembly 7 is depressed.

As illustrated in FIGS. 3, 5, and 7, a plurality of projections 73e are provided at the rim portion (the frame portion 73a or the supporting portion 73b) of the supporting member 73. In the present embodiment, as an example, the projections 73e are arranged with spaces therebetween along the rim portion of the supporting member 73. The projections 73e project from the frame portion 73a toward the inside (lower side) of the housing 3. As illustrated in FIGS. 3 and 4, the end portions 3s1 to 3s4 of the opening 3s in the wall portion 3k of the housing 3 are provided with flange portions 3u (wall portions) extending with a substantially constant width along the end portions 3s1 to 3s4 of the opening 3s, in positions separated at a predetermined distance (positions lowered by the thickness of the touchpad assembly 7) from the face 3a toward the inside (face 3b side or lower side) of the housing 3. The flange portions 3u overhang substantially parallel to the wall portion 3k toward the inside of the opening 3s. The flange portions 3u are provided with a plurality of openings 3v corresponding to the respective projections 73e. After the projections 73e are inserted through the openings 3v, the distal end portions of the projections 73e are heated and crushed to be expanded into a state thicker than the openings 3v, whereby head portions 73f of the projections 73e are provided. By such processing, the supporting member 73 is attached to the flange portions 3u. That is, the supporting member 73 is welded to the flange portions 3u (the wall portion 3k) of the housing 3.

In the present embodiment, as an example, as illustrated in FIG. 8, the reinforcing member 72 is configured in a quadrilateral (rectangular, as an example, in the present embodiment) and plate-like shape. The reinforcing member 72 is made, as an example, of a metal material (such as a ferrous material) that is harder than the supporting portion 73b (supporting member 73). The reinforcing member 72 comprises a wall portion 72a, reinforced portions 72b and 72c, and end portions 72d1 to 72d4. The wall portion 72a comprises a face 72a1 (upper face) and a face 72a2 (lower face, refer to FIG. 3). An opening 72e is provided in a position of the wall portion 72a near the end portion 72d1. The opening 72e is configured in a quadrilateral shape (rectangular shape, as an example, in the present embodiment). The opening 72e overlaps the opening 73d of the supporting portion 73b. As illustrated in FIG. 5, in the touchpad assembly 7, electronic components, such as the connector 76 and the elemental device 77, provided on the face 74b of the substrate 74 are exposed from the openings 72e and 73d overlapping each other. That is, in other words, the electronic components, such as the connector 76 and the elemental device 77, mounted on the substrate 74 are kept from interfering with the reinforcing member 72 and the supporting member 73 by the openings 72e and 73d.

In the present embodiment, as an example, the opening 72e (second opening) is provided in a position nearer to the end portion 72d1 (first end portion) than to the end portion 72d3 (second end portion). The stiffness in the area provided with the opening 72e is lower than the stiffness in the area without the opening 72e. As a result, in the present embodiment, as an example, the stiffness of the reinforcing member 72, and consequently the touchpad assembly 7, on the side near the end portion 72d1, that is, on the side near the area A1 of the supporting portion 73b (that is, the areas A3 of the supporting portion 73b) is lower than the stiffness of the reinforcing member 72, and consequently the touchpad assembly 7, on the side near the areas A2 of the supporting portion 73b. Consequently, according to the present embodiment, as an example, the touchpad assembly 7 is kept from being difficult to bend due to providing of the reinforcing member 72.

In the present embodiment, as an example, the reinforcing member 72 has flexibility (elasticity). As illustrated, for example, in FIG. 3, the reinforcing member 72 is provided over the range between the position overlapping the area A1 of the supporting portion 73b and the position overlapping the area A2 of the supporting portion 73b. The reinforcing member 72 also serves as an elastic member (flexible member) in areas overlapping the areas A3 of the supporting portion 73b. That is, the reinforcing member 72 can also reinforce the areas A3 of the supporting portion 73b that have flexibility. In the present embodiment, as an example, the reinforcing member 72 is made of a metal material, and thereby is easy to be made thinner than in the case of being made of a synthetic resin material.

In the present embodiment, as an example, by comprising the reinforcing member 72, the touchpad assembly 7 has a higher stiffness and strength than in the case of not comprising the reinforcing member 72. In addition, in the present embodiment, as an example, because of the reinforced portions 72b and 72c, the stiffness and strength of the touchpad assembly 7 are still higher than in the case of not comprising the reinforcing member 72.

The touchpad assembly 7 is still more difficult to bend in areas provided with the reinforced portions 72b and 72c. If the touchpad assembly 7 is soft, when the touchpad assembly 7 is depressed, the depressed portion is locally deformed, so that there are cases in which a displacement (stroke) of the movable portion 78b of the switch 78 is difficult to be obtained. In this respect, according to the present embodiment, as an example, the touchpad assembly 7 comprises the reinforced portions 72b and 72c, so that, when the touchpad assembly 7 is depressed, the touchpad assembly 7 is kept from being locally deformed, and the switch 78 is kept from being inoperative due to a lack in the displacement (stroke) of the movable portion 78b. That is, in other words, in the present embodiment, as an example, by providing the reinforced portions 72b and 72c on the touchpad assembly 7, the switch 78 is operated to be on by the pressing operation of the touchpad assembly 7 (an effective displacement [stroke] of the movable portion 78b is obtained) over a larger area than in the case of not providing the reinforced portions 72b and 72c.

In the present embodiment, as an example, the reinforced portion 72b is a projecting portion (recessed portion) of the wall portion 72a that projects on the face 72a2 side and is recessed on the face 72a1 side. The reinforced portion 72b extends in the direction along the end portion 72d3 (the end portion 3e) in a position between the opening 72e and the end portion 72d3. In the present embodiment, as an example, the reinforced portions 72c are projecting portions (wall portions) obtained by bending the wall portion 72a toward the face 72a2 side at the respective end portions 72d2 and 72d4. The reinforced portions 72c extend along the end portions 72d2 and 72d4. That is, in the present embodiment, as an example, the reinforced portion 72b and the two reinforced portions 72c intersect each other (at a right angle, as an example, in the present embodiment). Consequently, according to the present embodiment, as an example, the stiffness against bending in more directions is likely to increase than in the case in which the reinforced portion 72b and the reinforced portions 72c are parallel to each other.

In the present embodiment, as an example, as illustrated in FIG. 5, the reinforced portion 72b is provided over the range between one side (the end portion 72d2 side, or the left side in FIG. 5) and the other side (the end portion 72d4 side, or the right side in FIG. 5) of the switch 78, with the line of sight in the direction in which the switch 78 is depressed, that is, with the line of sight in the thickness direction (laminating direction) of the touchpad assembly 7 (in the direction along the arrow A in FIG. 5). Hence, according to the present embodiment, as an example, the stiffness of the touchpad assembly 7 is likely to increase in a larger area around the switch 78.

In the present embodiment, as an example, as illustrated in FIG. 5, the reinforced portions 72b and 72c overlap the area A2 of the supporting member 73 (the supporting portion 73b), but do not overlap the areas A3 of the supporting member 73. That is, in the present embodiment, as an example, the reinforced portions 72b and 72c are provided in positions distant from the position (the area A1) of the supporting portion 73b supported by the housing 3. Consequently, in the present embodiment, as an example, the touchpad assembly 7 is kept from being difficult to be displaced as a result of difficulty in elastic deformation of the areas A3 of the supporting member 73 caused by providing the reinforced portions 72b and 72c.

In the present embodiment, as an example, the reinforcing member 72 is made of a metal material having electric conductivity, and is positioned adjacent to the touchpad unit 71. As a result, the reinforcing member 72 can also serve as a ground electrode and an electromagnetic shield for the touchpad unit 71.

In the present embodiment, as an example, the face 72a1 of the reinforcing member 72 is bonded with the face 74b (lower face) of the substrate 74, and the face 72a2 of the reinforcing member 72 is bonded with the face 73b1 (upper face) of the supporting member 73. In the present embodiment, when the touchpad assembly 7 is assembled, a subassembly in which the touchpad unit 71 is integrated with the reinforcing member 72 is attached to the housing 3 with which the supporting member 73 is integrated. As described above, in the present embodiment, as an example, the frame portion 73a of the supporting member 73 is welded to the housing 3. Consequently, according to the present embodiment, as an example, labor hours and cost for the assembly is more likely to be reduced than in the case of attaching the touchpad assembly 7 in which the touchpad unit 71, the reinforcing member 72, and the supporting member 73 are integrated into one body to the housing 3. In addition, heat during welding can be kept from affecting the touchpad unit 71.

As has been described above, in the present embodiment, as an example, the electronic device 1 comprises the touchpad assembly 7 that comprises the reinforcing member 72. The reinforcing member 72 is made of a material harder than the supporting portion 73b. Hence, according to the present embodiment, as an example, the stiffness of the touchpad assembly 7 is likely to increase. Consequently, as an example, the area on the face 7a of the touchpad assembly 7 that can operate the switch 78 (operation unit) by depressing the face 7a is likely to be widened.

In the present embodiment, as an example, the reinforcing member 72 is made of a metal material. Hence, according to the present embodiment, as an example, the touchpad assembly 7 is easy to be made thinner than in the case in which the reinforcing member 72 is made, for example, of a synthetic resin material.

In the present embodiment, as an example, the reinforcing member 72 comprises the reinforced portions 72b and 72c in the positions (positions overlapping the area A2) distant from the position (the area A1) of the supporting portion 73b supported by the housing 3. Hence, according to the present embodiment, as an example, the touchpad assembly 7 is kept from being difficult to bend due to providing of the reinforced portions 72b and 72c.

In the present embodiment, as an example, the reinforced portions 72b and 72c extend over the range between one side and the other side of the switch 78, with the line of sight along the direction in which the movable portion 78b of the switch 78 (operation unit) is depressed (in the direction along the arrow A in FIG. 5). Hence, according to the present embodiment, as an example, the area on the touchpad assembly 7 that can operate the switch 78 is likely to be set wider.

In the present embodiment, as an example, the reinforced portion 72b and the reinforced portions 72c extend in the directions intersecting each other. Hence, according to the present embodiment, as an example, the area on the touchpad assembly 7 that can operate the switch 78 is likely to be set wider.

In the present embodiment, as an example, the opening 72e is provided in the position of the reinforcing member 72 nearer to the end portion 72d1 (first end portion) than to the end portion 72d3 (second end portion). Hence, according to the present embodiment, as an example, the touchpad assembly 7 is kept from being difficult to bend due to providing of the reinforcing member 72.

In the present embodiment, as an example, the reinforcing member 72 has flexibility, and is provided over the range between the position overlapping the area A1 (position supported by the housing 3) of the supporting portion 73b and the position overlapping the area A2 (position distant from the area A1) of the supporting portion 73b. Hence, according to the present embodiment, as an example, the reinforcing member 72 also serves as an elastic member (flexible member) in areas overlapping the areas A3 of the supporting portion 73b (areas where the supporting portion 73b bends). As a result, the reinforcing member 72 can also reinforce the areas A3 having flexibility.

In the present embodiment, as an example, the reinforcing member 72 is made of a metal material having electric conductivity. Hence, according to the present embodiment, as an example, the reinforcing member 72 can serve as a ground electrode (conductor) and an electromagnetic shield for the substrate 74.

### First Modification

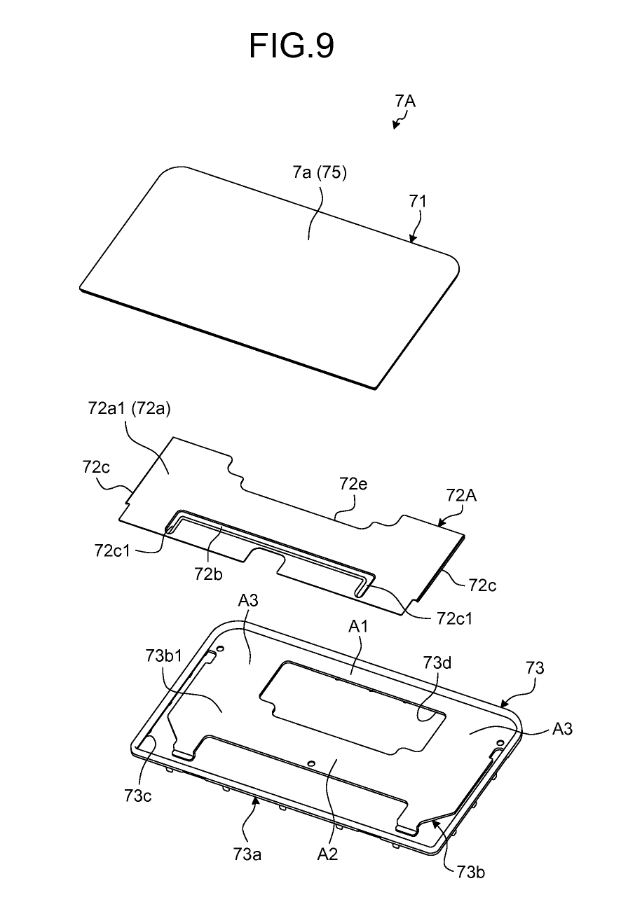

A reinforcing member 72A constituting a touchpad assembly 7A according to a first modification illustrated in FIG. 9 does not comprise a portion overlapping the areas A1 and A2 of the supporting portion 73b, but comprises portions overlapping the areas A3. The reinforced portions 72b and 72c1 that extend in directions intersecting each other (at a right angle, in the present modification) are connected to each other. With such a modification, the same results (effects) as those of the embodiment described above are also obtained.

Components can be partially replaced between the embodiment and the modification. Also, specifications (such as the structure, type, direction, shape, size, length, width, thickness, height, number, arrangement, position, and material) of each of the components can be put into practice by being modified as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a housing provided with an opening;
a touchpad unit exposed from the opening, comprising an operation surface, and configured to detect operations on the operation surface;
a supporting portion configured to be plate-like, supported by the housing, and configured to displaceably support the touchpad unit;
an operation unit configured to be depressed as the touchpad unit is displaced; and
a reinforcing member configured to be plate-like, fixed in a state of overlapping the touchpad unit or the supporting portion, and made of a material harder than the supporting portion.

2. The electronic device of claim 1, wherein the reinforcing member is made of a metal material.

3. The electronic device of claim 1, wherein the reinforcing member comprises a reinforced portion that is distant from a position of the supporting portion supported by the housing.

4. The electronic device of claim 3, wherein the reinforced portion extends over a range between one side and the other side of the operation unit, with a line of sight along a direction in which the operation unit is depressed.

5. The electronic device of claim 3, wherein
the reinforced portion comprises a first reinforced portion and a second reinforced portion, and
the reinforcing member comprises the first reinforced portion that extends in one direction and the second reinforced portion that extends in a direction intersecting the direction of the first reinforced portion.

6. The electronic device of claim 1, wherein
the reinforcing member comprises a first end portion that is near a position of the supporting portion supported by the housing and a second end portion that is more distant than the first end portion from the supported position, and
a second opening is provided in a position nearer to the first end portion than to the second end portion.

7. The electronic device of claim 1, wherein the reinforcing member is configured to be flexible and is provided over a range between a position overlapping a position of the supporting portion supported by the housing and a position distant from the supported position.

8. The electronic device of claim 2, wherein the reinforcing member is made of a metal material having electric conductivity, and is positioned adjacent to the touchpad unit.

9. An electronic device comprising:
a housing provided with an opening;
a touchpad exposed from the opening, comprising an operation surface, and configured to detect operations on the operation surface;
a supporting portion supported by the housing, and configured to displaceably support the touchpad;
an operation unit configured to be depressed as the touchpad is displaced; and
a reinforcing member fixed to the touchpad or the supporting portion.

10. A touchpad assembly comprising:
a touchpad unit exposed from an opening provided in a housing of an electronic device, comprising an operation surface, configured to detect operations on the operation surface, and displaceably supported by the housing; and
a reinforcing member fixed to the touchpad unit.
